(19) United States
(12) Patent Application Publication
(10) Pub. No.: US 2005/0082317 A1
(43) Pub. Date: Apr. 21, 2005

(54) Angled caulk nozzle

(76) Inventor: John Vernon Coll, Springfield, PA (US)

Correspondence Address: JOHN VERNON COLL, 533 W. SPRINGFIELD ROAD, SPRINGFIELD, PA, 19064, US

(21) Appl. No.: 10/843,989

(22) Filed: May 12, 2004

Related U.S. Application Data
(60) Provisional application No. 60/512,816, filed on Oct. 21, 2003.

(51) Int. Cl. B67B 5/00

(52) U.S. Cl. 222/326

(57) ABSTRACT

An angled caulk tube nozzle that includes a tapered nozzle end portion, degreed position(s), a caulk tube attachment portion, and a number of angled caulk tube gripping structures. The tapered nozzle end portion, the degreed position(s) section, and the caulk tube attachment portion are integrally formed to define an internal caulk passageway through the tapered nozzle end portion, the degreed position(s) section and the caulk tube attachment portion. The caulk tube attachment portion defines a caulk tube insertion opening in connection with the internal caulk passageway. Each of the plurality of angled caulk tube gripping structures has a bevel edged internal caulk tube engaging portion that extends into the internal caulk passageway adjacent to the caulk tube insertion opening in a manner such that as the angled caulk tube nozzle is screwed onto a caulk tube, the bevel edged internal caulk tube engaging portions each cut into and engage the caulk tube.

### TECHNICAL FIELD

The present invention relates to nozzles for dispensing caulking and similar viscous mixtures and more particularly to a the degreed angled caulk tube nozzle that is securable over the dispensing tube of a caulk container that includes a tapered nozzle end portion, an the degreed position(s) section, a caulk tube attachment portion, and a plurality of angled caulk tube gripping structures; the tapered nozzle end portion, the degreed position(s) section, and the caulk tube attachment portion being integrally formed to define an internal caulk passageway through the tapered nozzle end portion, the degreed position(s) section and the caulk tube attachment portion; the caulk tube attachment portion defining a caulk tube insertion opening in connection with the internal caulk passageway; each of the plurality of angled caulk tube gripping structures having a bevel edged internal caulk tube engaging portion extending into the internal caulk passageway adjacent to the caulk tube insertion opening in a manner such that as the angled caulk tube nozzle is screwed onto a caulk tube, the bevel edged internal caulk tube engaging portions each cut into and engage the caulk tube.

### BACKGROUND ART

Caulking is typically used to provide a resilient seal between two adjacent structures, such as a window frame and a brick wall, to prevent water and air from entering the gap between the two adjacent structures. Although caulking is desirable, it is often difficult to dispense the viscous caulk into the gap between the structures with the straight, tapered caulk tube conventionally provided with the caulk container. It would be a benefit, therefore, to have a caulk tube nozzle that was attachable over the caulk tube of the caulk container and which was sufficiently angled to allow a tapered nozzle end portion of the caulk tube nozzle to be oriented at a number of desirable angles with respect to a caulk tube attachment portion of the caulk tube nozzle. Additionally, because caulk is highly viscous, it could be difficult to maintain a caulk tube nozzle on the caulk tube. It would be a further benefit, therefore, to have a caulk tube nozzle that included a number of caulk tube gripping structures that could cut into and engage the sidewall of the caulk tube to prevent the caulk tube nozzle from being forced off the caulk tube by caulk flowing through the caulk tube nozzle.

### GENERAL SUMMARY DISCUSSION OF INVENTION

It is thus an object of the invention to provide a caulk tube nozzle that is angled.

It is a further object of the invention to provide an angled caulk tube nozzle that includes a number of caulk tube gripping structures that cut into and engage the sidewall of the caulk tube to prevent the caulk tube nozzle from being forced off the caulk tube by caulk flowing through the caulk tube nozzle.

It is a still further object of the invention to provide an angled caulk tube nozzle that includes a tapered nozzle end portion, an the degreed position(s) section, a caulk tube attachment portion, and a plurality of angled caulk tube gripping structures; the tapered nozzle end portion, the degreed position(s) section, and the caulk tube attachment portion being integrally formed to define an internal caulk passageway through the tapered nozzle end portion, the degreed position(s) section and the caulk tube attachment portion; the caulk tube attachment portion defining a caulk tube insertion opening in connection with the internal caulk passageway; each of the plurality of angled caulk tube gripping structures having a bevel edged internal caulk tube engaging portion extending into the internal caulk passageway adjacent to the caulk tube insertion opening in a manner such that as the angled caulk tube nozzle is screwed onto a caulk tube, the bevel edged internal caulk tube engaging portions each cut into and engage the caulk tube.

It is a still further object of the invention to provide an angled caulk tube nozzle that accomplishes some or all of the above objects in combination.

Accordingly, an angled caulk tube nozzle is provided. The angled caulk tube nozzle includes a tapered nozzle end portion, an the degreed position(s) section, a caulk tube attachment portion, and a plurality of angled caulk tube gripping structures; the tapered nozzle end portion, the degreed position(s) section, and the caulk tube attachment portion being integrally formed to define an internal caulk passageway through the tapered nozzle end portion, the degreed position(s) section and the caulk tube attachment portion; the caulk tube attachment portion defining a caulk tube insertion opening in connection with the internal caulk passageway; each of the plurality of angled caulk tube gripping structures having a bevel edged internal caulk tube engaging portion extending into the internal caulk passageway adjacent to the caulk tube insertion opening in a manner such that as the angled caulk tube nozzle is screwed onto a caulk tube, the bevel edged internal caulk tube engaging portions each cut into and engage the caulk tube.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a plain view of an exemplary embodiment of the angled caulk tube nozzle of the present invention showing the tapered nozzle end portion, with said nozzle at a (60) sixty degree angle.

FIG. 2 is a side elevation view embodiment of the angled caulk tube nozzle of the present invention showing the tapered nozzle end portion, with said nozzle at a (60) sixty degree angle with the capabilities of hosting angled positions from (1) one degree to (90) ninety degrees.

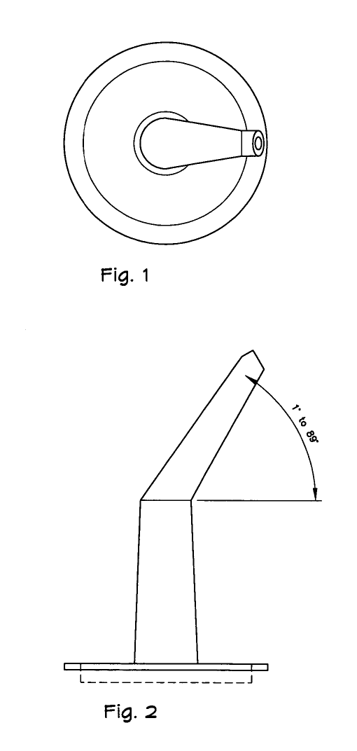

1. An angled caulk tube nozzle that is attachable to a caulk tube of a caulk container, said angled caulk tube nozzle comprising:
a tapered nozzle end portion;
a degreed position(s) section;
a caulk tube attachment portion; and
an angled caulk tube gripping structures;
said tapered nozzle end portion, said the degreed position(s) section, and said caulk tube attachment portion being integrally formed to define an internal caulk passageway through said tapered nozzle end portion, said the degreed position(s) section and said caulk tube attachment portion;
said caulk tube attachment portion defining a caulk tube insertion opening in connection with said internal caulk passageway;
each of said four angled caulk tube gripping structures having a bevel edged internal caulk tube engaging portion extending into said internal caulk passageway adjacent to said caulk tube insertion opening in a manner such that as said angled caulk tube nozzle is screwed onto a caulk tube, said bevel edged internal caulk tube engaging portions each cut a spiral thread into and engage the caulk tube.
